(19) United States
(12) Patent Application Publication
(10) Pub. No.: US 2010/0200205 A1
(43) Pub. Date: Aug. 12, 2010

(54) EXTRUDED PRODUCT MADE FROM ALUMINIUM ALLOY Al-Mg-Si WITH IMPROVED RESISTANCE TO CORROSION

(75) Inventors: Bruce Morere, Dijon (FR); Annabelle Bigot, Renage (FR); Jerome Pignatel, La Chapelle sur Erde (FR)

Correspondence Address: DENNISON, SCHULTZ & MACDONALD, 1727 KING STREET, SUITE 105, ALEXANDRIA, VA, 22314, US

(73) Assignee: ALCAN RHENALU, Courbevoie (FR)

(21) Appl. No.: 12/670,527

(22) PCT Filed: Jul. 21, 2008
(86) PCT No.: PCT/FR08/01073

§ 371 Date: Jan. 25, 2010

(30) Foreign Application Priority Data
Jul. 27, 2007 (FR) 0705511

(51) Int. Cl. F28F 21/00; C22C 21/02; C22C 21/08; F16L 9/00

(52) U.S. Cl. 165/180; 420/532; 138/177

(57) ABSTRACT

An extruded product, particularly a drawn tube made from an alloy of the 6XXX series with the following composition, in weight %: Mg: 0.4-0.7, Si: 0.4-0.7, Fe: 0.1-0.3, Zn: 0.16-0.3, Ti: 0.12-0.3, Mn<0.10, Cu<0.05, Cr<0.05, Ni<0.05. others<0.05 each and <0.15 in total, remainder being aluminum, with the ratio Si/Mg between 0.9 and 1.3. The tubes are advantageously used for cabin air-conditioning systems in motor vehicles using CO₂ as refrigerant gas. In such systems, the product offers an advantageous combination of good mechanical properties at operating temperatures and high resistance to perforating corrosion necessary for extended operating life without leaks.

### FIELD OF THE INVENTION

The invention relates to extruded products made of aluminum Al—Mg—Si alloy (series 6000 according to the nomenclature of the Aluminum Association) with improved to corrosion resistance, especially tubes designed in particular for piping or heat exchangers for automotive engineering.

### BACKGROUND OF RELATED ART

Today, three vehicles out of four sold in France have air-conditioning. In 2020, nine vehicles out of ten will be air-conditioned. Automobile air-conditioning has a considerable impact on climate change for two main reasons. The first is the extra fuel consumed. This depends greatly on the type of vehicle and how it is used, but is estimated at an average of 7% of fuel consumed. The second is related to losses of refrigerant. The fluid currently used today (HFC-R134a, CH2 FCF3) has an impact on the greenhouse effect approximately one thousand four hundred times greater than the equivalent mass of carbon dioxide (CO2) and it is usually accepted that each vehicle loses a third of the contents (approximately 900 g) of the cooling circuit each year.

Many studies are currently examining the replacement of hydrofluorocarbons (HFC) with CO2 for air-conditioning systems. Even though CO2 is a greenhouse gas, its impact is much lower than that of HFCs, which may make it possible to decrease the noxiousness of emissions related to leaks.

An air-conditioning system running on CO2 as a refrigerating gas is based on the compression and expansion of gas. A compressor compresses the CO2 at high pressure and this then moves into a gas cooler (usually called condenser, but in which condensation does not occur when the refrigerant is CO2), then into an internal heat exchanger (which allows heat exchange with the low pressure zone).

The CO2, still as a gas then moves into a pressure reducer from which comes a liquid which cools the passenger compartment by passing through an evaporator. The low pressure gas then accumulates before circulating inside the internal heat exchanger and returning to the compressor for a new cycle. Extruded products made of aluminum can be used to manufacture the heat exchangers (gas cooler and evaporator) and/or to produce the piping allowing the refrigerant to circulate between the various parts of the cooling circuit.

The use of CO2 as refrigerant is made difficult because of the pressure at which it must be used. The critical temperature of CO2 is lower than that of HFC-134a and its to critical pressure is higher, which means that the air-conditioning system has to run at higher pressures and temperatures than those currently in use, whether in the high pressure part or the low pressure part of the circuit. The materials used in the air-conditioning circuit must therefore be more hard-wearing than currently used materials, while maintaining performance levels that are at least equivalent in terms of manufacture, shaping, assembly and corrosion resistance. For good refrigerating efficiency, CO2 therefore needs to be compressed with high pressures of about 100 to 200 bar. Because of this, in order for CO2 to be used as a refrigerant, the piping must withstand an operating pressure of 200 bar for high temperatures of 130-170° C., which is high compared to current conditions: about 5 bar at 60° C.

Alloys have been proposed for the production of flat tubes for heat exchangers (gas coolers and evaporators) of air-conditioning systems using CO2 as refrigerating gas.

JP 2005-068557 describes an alloy composed as follows (% by weight)

Mn: 0.8-2, Cu: 0.22-0.6, Ti: 0.01-0.2, Fe: 0.01-0.4, Zn<0.2, Sn<0.018, In <0.02.

JP 2007-070699 describes an alloy composed as follows (% by weight)

Si: 0.31-0.7, Fe: 0.3-0.6, Mn: 0.01-0.4, and as an option Ti 0.01-0.3, Zr 0.05-0.3, Cr 0.05-0.3.

These alloys do not seem to make it possible to reach some of the required performance levels in terms of hardness, in particular for tubes designed for piping. Conventionally, alloys used for the manufacture of tubes designed for piping belong to series 3XXX. Patent application WO 02/055750 by the applicant relates to an alloy with improved corrosion resistance composed as follows: Si<0.30, Fe: 0.20-0.50, Cu<0.05, Mn: 0.5-1.2, Mg<0.05, Zn<0.50, Cr: 0.10-0.30, Ti<0.05, Zr<0.05.

From patent application WO 99/18250, an alloy of the series 3XXX composed as follows Cu<0.03, Mn: 0.1-1.5, Ti 0.03-0.35, Mg<1.0, Ni<0.01, Zn: 0.05-1.0, Zr<0.3, Fe<0.50, Si<0.50 Cr<0.20 is also known.

In addition, certain alloys of series 6XXX are known from standard EN 754-2 for the fabrication of drawn tubes.

Among the alloys with good potential for spinning, alloys AA6060, AA6061 and to AA6063 may be mentioned.

Alloy AA6060 is composed as follows:

Mg: 0.35-0.6, Si: 0.30-0.6, Fe: 0.10-0.30, Cu<0.10, Mn<0.10, Cr<0.05, Zn<0.15, Ti<0.10, others<0.05 each and <0.15 total, the rest aluminum.

Alloy AA6061 is composed as follows:

Mg: 0.8-1.2, Si: 0.40-0.8, Fe: <0.7, Cu: 0.15-0.40, Mn<0.15, Cr 0.04-0.35, Zn<0.25, Ti<0.15, others<0.05 each and <0.15 total, the rest aluminum.

Alloy AA6063 is composed as follows:

Mg: 0.45-0.9, Si: 0.20-0.6, Fe: <0.35, Cu<0.10, Mn<0.10, Cr<0.10, Zn<0.10, Ti<0.10, others<0.05 each and <0.15 total, the rest aluminum.

Application EP 0 251 180 cites alloys AA6061 and AA6063 for the fabrication of tubes designed for automobile applications.

In addition, alloy AA6106, composed as follows:

Mg: 0.40-0.8, Si: 0.30-0.6, Fe<0.35, Cu<0.25, Mn<0.05-0.20, Cr<0.20, Zn<0.10, others<0.05 each and <0.15 total, the rest aluminum, is also known by the applicant for the production of drawn tubes.

The problem which the present invention answers is to manufacture a product extruded from alloy 6XXX with improved corrosion resistance and mechanical properties, in order to be able to withstand high pressures, especially for operating temperatures ranging between 130 and 170° C., and with identical or higher performance levels in terms of manufacture, shaping, assembly and corrosion resistance than those of series 3XXX, 5XXX and 6XXX.

### SUBJECT OF THE INVENTION

The subject of the invention is a extruded product, in particular a drawn tube, made of an alloy of series 6XXX composed as follows (% by weight):

Mg: 0.4-0.7, Si: 0.4-0.7, Fe: 0.1-0.3, Zn: 0.16-0.3, Ti 0.12-0.3, Mn<0.10, Cu<0.05, Cr<0.05, Ni<0.05, others<0.05 each and <0.15 total, the rest aluminum, in which the ratio Si/Mg lies between 0.9 and 1.3.

Contents are preferably (% by weight): Mg: 0.5-0.6, Si: 0.5-0.6, Fe: 0.15-0.25, to Zn: 0.16-0.25, Ti 0.16-0.25, Mn<0.05, Cu<0.03, Cr<0.03, Ni<0.03, others<0.05 each and <0.15 total, the rest aluminum, in which the ratio Si/Mg lies between 1.0 and 1.2.

Another subject of the invention is the use of a product extruded according to the invention for the manufacture of motor vehicles.

### DESCRIPTION OF THE INVENTION

Unless otherwise stated, all indications relating to the chemical composition of alloys are expressed as a percentage by weight. In a mathematical expression, “Si” means the silicon content expressed as a percentage by weight; this applies mutatis-mutandis to the other chemical elements. The designation of alloys follows the rules of The Aluminum Association, known to experts in the field, as well as EN standard 573-1. The metallurgical states are defined in European standard EN 515. The chemical composition of standardized aluminum alloys is defined for example in EN standard 573-3. Unless otherwise specified, static mechanical characteristics, i.e. breaking strength Rₘ, yield stress R_{p0.2}, and elongation at break, are determined by a tensile test according to standards EN 10002-1 and EN 754-2. The term “extruded product” includes so-called “drawn” products, i.e. products which are manufactured by spinning followed by drawing.

Unless otherwise specified, the definitions of European standard EN 12258-1 apply. The alloy of series 6XXX according to the invention has added titanium and zinc as compared to alloys AA6060 and AA6063. The zinc content must range between 0.16 and 0.3% by weight and preferably between 0.16 and 0.25% by weight. The titanium content must range between 0.12 and 0.3% by weight and preferably between 0.16 and 0.25% by weight. In addition, the Cr, Cu and Ni content must be kept low enough to be considered as mere impurities: less than 0.05% by weight and preferably less than 0.03% by weight. The alloy according to the invention therefore differs from alloy AA6061 which contains 0.04-0.35% Cr by weight and 0.15-0.40% Cu by weight. The combination of added Ti and Zn improves both the mechanical properties and corrosion resistance.

The magnesium content lies between 0.4 and 0.7% by weight and preferably between 0.5 and 0.6% by weight. The silicon content lies between 0.4 and 0.7% by to weight and preferably between 0.5 and 0.6% by weight. Adding silicon and magnesium with a content of at least 0.4% by weight and preferably at least 0.5% by weight makes it possible to obtain the required mechanical characteristics. The magnesium content must however be limited to a maximum of 0.7% by weight and preferably to 0.6% by weight to ensure satisfactory product solderability and good performance in terms of extrusion potential. The silicon content must also be limited to a maximum of 0.7% by weight and preferably to 0.6% by weight. The ratio Si/Mg lies between 0.9 and 1.3 and preferably between 1.0 and 1.2.

The manganese content must be lower than 0.10% by weight and in preferably lower than 0.05% by weight.

The iron content must range between 0.1 and 0.3% by weight and preferably between 0.15 and 0.25% by weight. Too high an iron content works to the detriment of corrosion resistance and a maximum content of 0.3% by weight is necessary, a maximum content of 0.25% by weight being preferred. For economic reasons of recycling the iron content must be at least 0.1% by weight and preferably at least 0.15% by weight.

Adding other elements may have a harmful effect on the alloy, and these must therefore each have a content of less than 0.05% by weight and less than 0.15% by weight in total.

The manufacturing process for extruded products according to the invention involves casting billets of the alloy indicated, homogenizing the billets, reheating and spinning them to obtain a straight length of tube or a coil, solution heat treatment and hardening and, as an option, one or more drawing passes to bring the product to the required dimensions. The tube may advantageously be annealed at a temperature ranging between 400° C. and 550° C. to improve its ductility. Preferably, the products extruded according to the invention are used in T4 state, i.e. maturation is carried out at room temperature. The products according to the invention may be obtained by hardening on a press. In another embodiment of the invention, the products extruded according to the invention undergo tempering which brings them to the T6 state, in order to maximize mechanical resistance.

The products according to the invention have a grain size lower than 45 μm and preferably lower than 25 μm.

The products according to the invention have high mechanical resistance in state to T4. In T4 state the breaking strength at room temperature is increased by more than 50% compared to a 3XXX alloy product according to application WO 02/055750 in H12 state and by more than 10% compared to a 6060 alloy product in T4 state. The advantage is confirmed for tests carried out at high temperature. In T4 state the breaking strength at 170° C. is increased by almost 60% compared to a 3XXX alloy product according to application WO 02/055750 in H12 state and by almost 10% compared to an alloy 6060 product in T4 state. In particular, tubes according to the invention have, in T4 state, a breaking strength Rₘ greater than 170 MPa at room temperature and greater than 140 MPa at 170° C. Moreover, products extruded according to the preferential composition of the invention have, in T4 state, a breaking strength Rm greater than 180 MPa at room temperature and greater than 150 MPa at 170° C. Elongation at break A % obtained with products according to the invention is high: greater than 25% both at room temperature and at 170° C. The product according to the invention therefore has significant advantages in terms of potential for shaping and breaking strength, in particular when compared to 3XXX alloy products according to application WO 02/055750.

The products according to the invention also have a high perforating corrosion resistance which makes it possible to obtain long periods of use without leakage. In particular, the products according to the invention do not show deep pitting during salt spray test of the SWAAT type as per standard ASTM G85A3, whereas under the same conditions, these are observed for alloy products AA6106, AA6060 and even for alloy AA6060 products in which titanium has been added. Unexpectedly, the combined addition of titanium and zinc means that the products according to the invention can reach a corrosion resistance in T4 state equivalent to that obtained with 3XXX alloy products according to application WO 02/055750.

The preferred shape of the product extruded according to the invention is a cylindrical tube comprising only one cavity.

Products extruded according to the invention can be used in particular as tubes in motor vehicle manufacture. In particular, products extruded according to the invention can be used as lines for fuel, oil, refrigerant or brake fluid for cars, and as tubes designed for heat exchangers for engine cooling and/or air-conditioning systems for motor vehicle passenger compartments, especially if they use CO2 as a refrigerating gas. Tubes, in particular tubes drawn according to the invention are more particularly suitable for being used in the form of cylindrical tubes, comprising only one cavity for transfer piping for fluid used in air-conditioning systems for motor vehicle passenger compartments using CO2 as a refrigerating gas.

### Example

Billets were cast and homogenized in 5 alloys indexed A to F.

Alloys A, B, C and D are prior art compositions. Alloy A belongs to series 5xxx, alloy B according to application WO02/055750 belongs to series 3XXX, and alloys C and D belong to series 6XXX. Alloy E is a 6060 alloy to which titanium has been added, and alloy F is in conformity with the invention.

Compositions (% by weight) are given in table 1.

TABLE 1
Composition of alloys A to F (% by weight).

| alloy | Ref, | Si | Fe | Cu | Mn | Mg | Cr | Zn | Ti |
|---|---|---|---|---|---|---|---|---|---|
| AA5049 | A | 0.13 | 0.17 | 0.03 | 0.78 | 1.83 | 0.01 | 0.01 | 0.02 |
| 3XXX | B | 0.1 | 0.27 | — | 0.97 | — | 0.19 | 0.19 | 0.01 |
| AA6106 | C | 0.44 | 0.18 | 0.11 | 0.10 | 0.51 | — | 0.01 | 0.01 |
| AA6060 | D | 0.54 | 0.22 | — | 0.08 | 0.52 | — | 0.02 | 0.01 |
| AA6060 + Ti | E | 0.53 | 0.20 | 0.03 | 0.07 | 0.52 | — | 0.01 | 0.17 |
| invention | F | 0.53 | 0.22 | 0.04 | 0.08 | 0.53 | — | 0.18 | 0.17 |

The billet of alloy A was extruded in finite lengths of straight tubes, which were then drawn and annealed to obtain a diameter of 16 mm and a thickness of 1.25 mm in final state O.

The billets of alloy B, C, D, E and F were extruded in tube coils. The alloy products 6XXX (C, D, E and F) were hardened on a press. These coils were then drawn and annealed at a temperature ranging between 400 and 550° C. to obtain a diameter of 10 or 11 mm and a thickness of 1.25 or 1.5 mm. No significant difference was recorded between the five alloys B, C, D, E and F concerning their potential for spinning and drawing. The coils in sample B then underwent a new drawing pass to bring them to the H12 state as per standard EN 515. On samples of the 6 tubes, the breaking strength Rₘ (in MPa) the yield stress R_{p0.2} (in MPa) and elongation at break A %, were measured at room temperature and at 140° C. and 170° C. in order to simulate the conditions using the tube in an air-conditioning system using CO2 as a refrigerant. The results are given in table 2.

TABLE 2
Mechanical characteristics obtained at room temperature and at high
temperature

| | Temperature | | | Temperature | | | Temperature | | |
|---|---|---|---|---|---|---|---|---|---|
| | 20° C. | | | 140° C. | | | 170° C. | | |
| | Rp_{0.2} | Rm | | Rp_{0.2} | Rm | | Rp_{0.2} | | |
| Ref. | (MPa) | (MPa) | A % | (MPa) | (MPa) | A % | (MPa) | Rm (MPa) | A % |
| A | 95 | 206 | 28 | 93 | 187 | 31 | 93 | 172 | 34 |
| B | 122 | 132 | 29 | 112 | 112 | 4 | 106 | 106 | 5 |
| C | 131 | 178 | 25 | 114 | 153 | 20 | 123 | 166 | 19 |
| D | 125 | 185 | 27 | 118 | 162 | 24 | 113 | 155 | 23 |
| E | 119 | 182 | 28 | 111 | 159 | 25 | 115 | 162 | 24 |
| F | 121 | 206 | 31 | 116 | 185 | 27 | 109 | 168 | 27 |

The extruded products obtained with the four alloys C, D, E, F of series 6xxx all show fairly similar mechanical characteristics, comparable with those obtained with alloy A of series 5XXX. Out of the 6XXX alloys tested, alloy F according to the invention has the best properties with in particular a breaking strength greater by more than 10% for a test carried out at room temperature, and by almost 10% for a test carried out at 170° C., compared to that obtained with alloy AA6060.

Alloy F according to the invention shows in particular improved mechanical characteristics compared to alloy B according to application WO02/055750 of prior art: a breaking strength Rₘ increased by more than 50% both at room temperature and at 140° C. or 170° C., and an elongation at break A % greater than 25% both at room temperature and at 140° C. or 170° C.

The average grain size was measured by the intercept method on tube samples B, D, E and F. The results are given in table 4. The tubes obtained with the alloy according to the invention have fine, equiaxed grains of about 25 μm.

TABLE 4
Average grain size measured by the intercept method.

| | Direction L | Direction T | Average |
|---|---|---|---|
| Alloy | (μm) | (μm) | (μm) |
| B | 20 | 16 | 18 |
| D | 36 | 34 | 35 |
| E | 26 | 26 | 26 |
| F | 25 | 24 | 24 |

Corrosion resistance was measured using the SWAAT test (Sea Water Acetic Acid Test) as per standard ASTM G85 A3. Measurements were made for durations of 500 cycles at a temperature of 49° C. on three tubes of length 200 mm of each alloy A, B C, D, E and F. At the end of the test, the tubes were removed from the enclosure and pickled in a 68% nitric acid solution in order to dissolve the corrosion products. The depth of pitting was then measured optically on the surface of each tube by defocusing, and the average depths of the 5 deepest pits were calculated. The average PAv of the values obtained for the 3 tubes was then calculated. Corrosion resistance improves as PAv decreases. The results of 5 successive SWAAT test campaigns are given in table 3. The number of * signs indicates the number of tubes bored in the batch of three tube tested.

TABLE 3
Results obtained with the SWAAT corrosion test.

| Test | Alloy A | Alloy B | Alloy C | Alloy D | Alloy E | Alloy F |
|---|---|---|---|---|---|---|
| campaign | PAv (μm) | PAv (μm) | PAv (μm) | PAv (μm) | PAv (μm) | PAv (μm) |
| 1 | 1110 | Not tested | 1020 | Not tested | Not tested | Not tested |
| 2 | 1250*** | 220 | Not tested | 1250*** | Not tested | Not tested |
| 3 | Not tested | 210 | 1250*** | 750 | Not tested | Not tested |
| 4 | Not tested | 430 | Not tested | 910 | 550 | 350 |
| 5 | Not tested | 320 | Not tested | 920 | 540 | 200 |

It can be seen that alloy F according to the invention has much better corrosion resistance than that of the other alloys C, D, E of the same series 6xxx, and than that of alloy A of series 5xxx. Alloy F has no deep pitting, given that within the context of this invention the term “deep pitting” means a PAv value greater than 0.5 mm.

The test alloy E with titanium pits more deeply than alloy F, which shows the beneficial effect on corrosion resistance of the combined addition of Ti and Zn, as compared with adding titanium alone.

Alloy F according to the invention has equivalent corrosion resistance to that of alloy B, according to application WO02/055750 of prior art, reputed for its advantageous corrosion resistance properties.

Alloy F according to the invention provides an advantageous combination of high mechanical properties at the temperatures at which automobile air-conditioning systems using CO2 fluid operate, and high resistance to perforating corrosion necessary in order to obtain long periods of use without leakage.

1. Extruded product, in particular a drawn tube, made of alloy 6XXX composed as follows (% by weight):
Mg: 0.4-0.7, Si: 0.4-0.7, Fe: 0.1-0.3, Zn: 0.16-0.3, Ti 0.12-0.3, Mn<0.10, Cu<0.05, Cr<0.05, Ni<0.05, others<0.05 each and <0.15 total, the rest aluminum, in which the ratio Si/Mg lies between 0.9 and 1.3.

2. Product according to claim 1, characterized in that Zn<0.16-0.25% by weight.

3. Product according to claim 1, characterized in that Ti 0.16-0.25% by weight.

4. Product according to claim 1, characterized in that Mg: 0.5-0.6% by weight.

5. Product according to claim 1, characterized in that Si: 0.5-0.6% by weight.

6. Product according to claim 1, characterized in that Mn<0.05% by weight.

7. Product according to claim 1, characterized in that Fe: 0.15-0.25% by weight.

8. Product according to claim 1, characterized in that (as a % by weight) Cr<0.03%, Cu<0.03, Ni<0.03.

9. Extruded product according to claim 1, characterized in that its grain size is less than 45 μm.

10. Extruded product according to claim 1, characterized in that its breaking strength Rm in state T4 is greater than 170 MPa at room temperature, and greater than 140 MPa at 170° C.

11. Extruded product according to claim 10, composed as follows (% by weight) mg: 0.5-0.6, Si: 0.5-0.6, Fe: 0.15-0.25, Zn: 0.16-0.25, Ti 0.16-0.25, Mn<0.05, Cr<0.03, Cu<0.03, Ni<0.03 others<0.05 each and <0.15 total, the rest aluminum, in which the ratio Si/Mg ranges between 1.0 and 1.2, characterized in that in state T4 its breaking strength Rm is greater than 180 MPa at room temperature and greater than 150 MPa at 170° C.

12. Product extruded according to claim 11, characterized in that it does not show any deep pitting during a test of the salt spray type as per ASTM G85 A3.

13. Product according to claim 11, characterized in that this is a cylindrical tube comprising only one cavity.

14-17. (canceled)

18. A line for fuel, oil, brake fluid or refrigerant for a motor vehicle comprising a product according to claim 11.

19. A line according to claim 18, which is a heat exchanger of an engine cooling system or air-conditioning system for a passenger compartment of a car in which CO₂ is used as a refrigerating gas.

20. A line according to claim 18, in the form of a cylindrical tube comprising a single cavity, as piping for transfer of fluid in a passenger compartment air-conditioning system using CO₂ as a refrigerating gas.
